(19) United States
(12) Patent Application Publication
(10) Pub. No.: US 2008/0072907 A1
(43) Pub. Date: Mar. 27, 2008

(54) Oxygen conserver design for general aviation

(75) Inventors: Geoffrey Deane, Goleta, CA (US); Brenton Taylor, Kenwood, CA (US)

Correspondence Address: MARK RODGERS, 1590 SAN ROQUE ROAD, SANTA BARBARA, CA, 93105, US

(73) Assignee: Inogen Corporation

(21) Appl. No.: 11/900,775

(22) Filed: Sep. 12, 2007

Related U.S. Application Data
(60) Provisional application No. 60/846,677, filed on Sep. 22, 2006.

(51) Int. Cl. A62B 7/00

(52) U.S. Cl. 128/204.26

(57) ABSTRACT

The invention is multi-port oxygen conserver design, particularly suited for general aviation applications. The novel conserver provides separate bolus control capability for multiple users from a common oxygen supply. Thus a mix of gas usage reduction modes can be employed depending on whether the user is a pilot or passenger, operating altitude, and availability of oxygen, while maintaining safe operation.

### RELATED APPLICATIONS

This application claims priority to U.S. provisional application Ser. No. 60/846,677, Filed Sep. 22, 2006

### BACKGROUND OF THE INVENTION

The present invention relates to oxygen delivery for aircraft pilots and passengers, and is particularly applicable to supplemental oxygen requirements for general aviation.

Pilots of general aviation aircraft are required to use supplemental oxygen when above 12,500 feet in altitude for greater than 30 minutes. When flying above 14,000 feet, pilots must use oxygen at all times. Passengers must have oxygen available at altitudes greater than 15,000 feet. Currently, this requirement is handled by aircraft carrying bottles of compressed oxygen or chemical oxygen generators when planning to operate in a regime requiring supplemental oxygen. Such bottles are heavy, and must be re-filled or replaced often when used with current supplemental oxygen systems. Other oxygen sources, such as oxygen concentrators, might be employed, but devices of this type suitable for small aircraft, would typically require a method of conserving oxygen used by passengers and pilots, to avoid the need for an inconveniently large and heavy high capacity concentrator. Use of a device called a conserver, which is placed in the product line between an oxygen source and a user, potentially could improve the situation for either oxygen bottles or a concentrator solution for supplemental oxygen.

The conserver, many designs of which are known in the art, is depicted in a general sense in FIG. 1. A conserver generally is placed between oxygen supply 1 and a user, who accesses the conserver through a breathing device such as a cannula. Many types of cannula are known in the art, and do not form part of the novelty of the invention. A breath sensor, 4, typically consisting of a pressure transducer and detection circuit, senses a user's breath demand, and responds by delivering a volume of oxygen-rich gas (known as a bolus) to the user through a valve 3. This bolus, which is significantly less than the total volume of a typical inhalation, is entrained in the breath's air intake, and mixes with the air, eventually reaching the lungs, esophagus, and respiratory cavities (nose and mouth). Approximately half of an inspiration enters the lungs, where oxygen is absorbed. Elevated oxygen concentrations in this volume result in greater transfer of the gas to the blood. Because the lungs can only make use of oxygen in the volume that reaches them, conserver designs try to ensure that the bolus is delivered during the portion of an inhalation that actually reaches the lungs, typically the first 50% of a breath. Thus quick delivery of the bolus allows smaller boluses to be delivered while still satisfying the user's need for oxygen. Thus, the conserver delivers an effective amount of oxygen in relatively small, short bursts, constituting a more efficient use of the oxygen supply, whether sourced from finite supplies such as bottles or, fixed rate supplies, such as small concentrators. Such conservers are described in co-pending U.S. application Ser. Nos. 10/192,194, 11/170,743, and 11/274,275, which are incorporated in their entirety by reference. Typically a conserver will also have programmable logic, 2, which allows for the valve timing, and thus bolus characteristics, to be adjusted by various inputs, such as required aggregate oxygen delivery rate for example.

Although individual conservers of the type currently known could be used with oxygen supplies with finite capacities such as compressed oxygen cylinders, such conservers could not be plumbed together for use with oxygen concentrators or other rate-limited oxygen sources, because they do not effectively deliver oxygen using an oxygen source without a pressure regulator and similarly, do not have means to match their output to the rate of oxygen production of a concentrator. Known medical oxygen conservers would also not be well-suited to the general aviation requirements where oxygen demand is determined by altitude and not medical need. Thus, it is the object of this invention to provide a conserver which is usable in a general aviation environment and achieves the result of more efficient use of an oxygen supply while providing adequate supplemental oxygen for higher altitude aircraft operation from a rate limited oxygen source.

### SUMMARY OF THE INVENTION

The invention is a multi-port oxygen conserver system for general aviation, including at least one oxygen source input, at least pilot oxygen output port and at least one passenger output port, wherein each port includes a breath pressure sensor and a gas control valve, and each system includes an ambient pressure input, which in some embodiments is connected to an integrated pressure sensor, or aircraft instrumentation and a CPU, adapted to acquire the breath pressure sensors' or the aircraft's altitude data and to independently control the valves' timing. In one embodiment, the system further includes at least one back-up oxygen source port, a pressure sensor adapted to read the source pressure and be read by the CPU and, a source control valve, controlled by the CPU adapted to select either the primary source or the back-up source. In a preferred embodiment, the conserver system includes a user input panel adapted to communicate with the CPU.

In various embodiments, the controller inputs and operations include:
1. Individual pilot and passenger flow settings
2. Pilot only flow setting
3. Production capacity distribution:
4. Altitude adjusting flow setting:
5. Adaptive auto-pulse:
6. Pilot selective delivery

### BRIEF DESCRIPTION OF THE DRAWINGS

The detailed description of how to make and use the invention will be facilitated by referring to the accompanying drawings.

FIG. 1 depicts the general operation of a conserver.

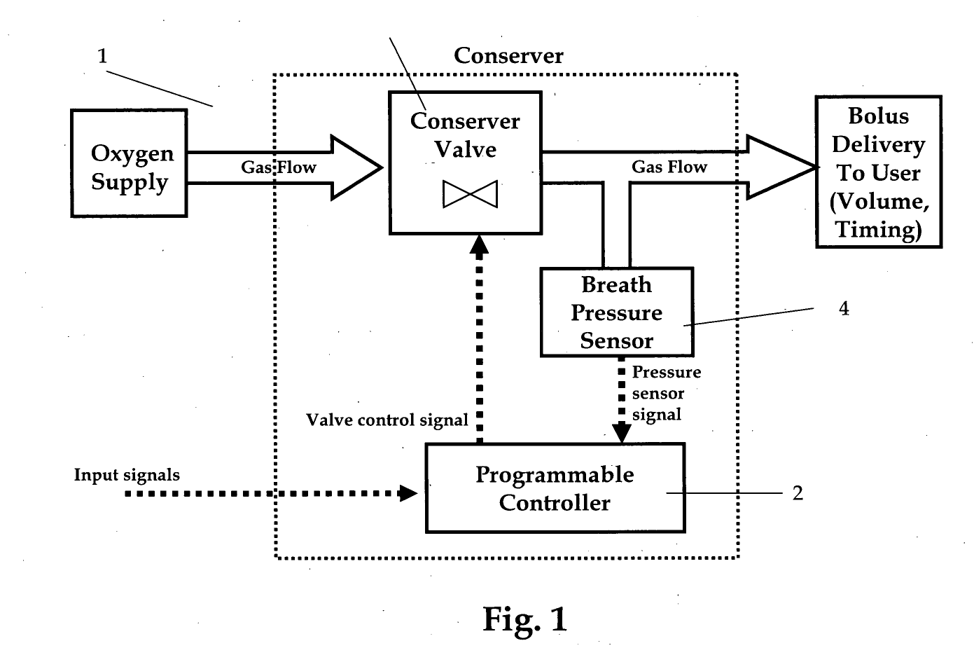

FIG. 2 depicts a multiport conserver according to the invention

### DETAILED DESCRIPTION OF THE INVENTION

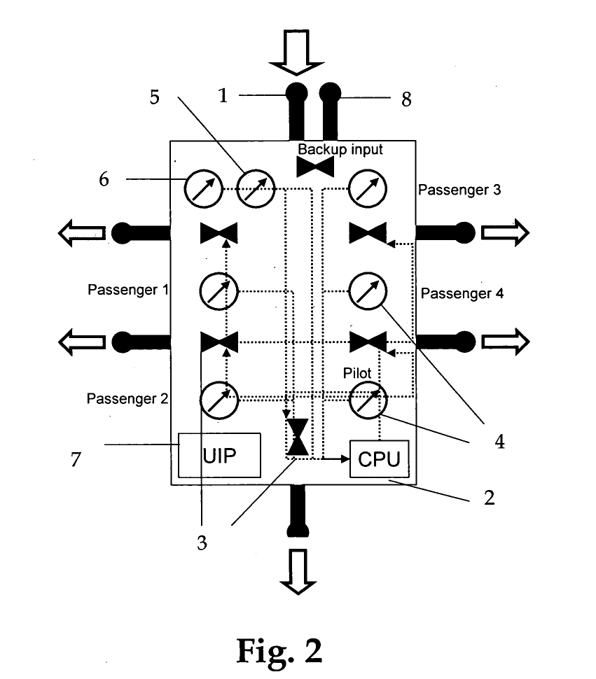

Referring to FIG. 2, a conserver of the present invention is shown. The conserver receives pressurized oxygen-rich air from a supply 1, which could either be a finite capacity supply such as compressed gas bottles, or a limited rate supply such as an oxygen concentrator or other oxygen generating system. Both supply types could be available either simultaneously or in rotation. By allowing dual source inputs to the conserver, the invention provides an automated means for backup oxygen based on flow demand from passengers or to automatically switch from a depleted or faulted primary oxygen source to a backup source without interrupting the delivery of oxygen to the pilot and passengers. A concentrator is the preferred approach of the inventors, as electrical power is typically available, and therefore a concentrator needs very little service compared to refilling gas bottles. The utilization of an oxygen conservation system in conjunction with an oxygen concentrator also removes time constraints from the flight duration that might otherwise be present using gas bottles or chemical oxygen generators. An exemplary suitable concentrator is described in referenced U.S. application Ser. No. 10/192,194. If needed, such a concentrator could be supplemented by gas bottles for circumstances where the rate required exceeds the capacity of the concentrator. In any case, the projected increase in time before re-fill for gas bottles, using the novel conserver, is a factor of six, so the invention provides significant improvement even for the case where bottles only are used.

At least two independent ports are advantageous for most general aviation applications, as the pilot's needs are greater than passengers', both by law and for safety reasons. Thus the conserver will preferably have at least two distribution ports serviced by valves 3. Each valve will preferably have an associated breath sensor 4. In the example shown, four passenger ports and one pilot port are shown, each with its own valve and sensor. Also, by way of example, one controller (CPU) 2 is shown which controls valve timing for each valve independently and manages the oxygen supply and distribution for the whole plane. Of course, multiple controllers could also be employed. The control of the valve timing determines the bolus volume, and therefore gas usage rate for each port. The oxygen source pressure sensor 5 allows the source of oxygen to be monitored for safety purposes and also for the bolus delivery timing to be adjusted to maintain proper oxygen volume delivery even as the source pressure varies with altitude or as a finite oxygen source is depleted beyond the regulator's set-point. Rate limited oxygen concentrators generally produce oxygen based on a pressure ratio between a high pressure, PH, and a low pressure, PL where, the backpressure in the system changes with altitude, which would make current conserver technologies give unreliable bolus volume doses. The ambient pressure sensor 6 allows adjustment and response to the changing ambient pressure conditions without manual intervention by the flight crew. The ambient pressure sensor may also be used as a trigger for activating the oxygen supply when altitude is reached. Alternatively, ambient pressure could be acauired from the aircraft's instrumentation. A variety of user inputs or pre-programmed modes allow for significant flexibility in how gas is used by each passenger and pilot, thereby allowing for a variety of ways to reduce gas utilization while maintaining safety. The user interface panel (UIP) 7 enables the conserver to be adapted to suit the number of passengers in a plane and to adjust the amount of oxygen delivered to each patient independently. The UIP also functions to notify the flight crew of any errors or alarm conditions detected in the oxygen supply and delivery system. The backup oxygen input system 7 allows the conserver system and CPU to switch over to a backup supply in situations where the primary source is depleted or when the demanded delivery rate exceeds the capacity of the primary oxygen source. In cases of emergency or unexpected changes in altitude this backup system can ensure proper oxygen delivery without flight crew intervention.

Various exemplary modes of operation include:

1. Individual pilot and passenger flow settings:
a. Each distribution port on the conserver would enable users to select the appropriate flow setting for their physical condition and flying altitude
   2. Pilot only flow setting:
b. The pilot would select the amount of oxygen required based on flying altitude and physical condition.
c. The conserver would then distribute the remaining oxygen to the passengers evenly based on total minute-volume delivery (assuming a fixed-rate oxygen generating system as the oxygen source).
   3. Production capacity distribution:
d. The conserver could deliver the entire production capacity of the supply to the passengers and pilot based solely on the number of active ports. This would ensure maximum delivery of oxygen up to the capacity of the source.
e. Each position could have a simple ±switch that would refine the delivery amount at a given port to allow for some individualization of oxygen delivery.
   4. Altitude adjusting flow setting:
f. The conserver's ambient pressure sensor would adjust the dosage rate to the pilot based on the flying altitude. Dosing could commence at 12,500 feet during daytime hours and 5,000 feet during nighttime hours and proportionally increase with altitude to the maximum rate of delivery based on the oxygen source.
g. The conserver could alternately have an altitude adjustment setting where the pilot would select the approximate flying altitude and the conserver would deliver a fixed amount based on that setting up to the maximum delivery rate of the oxygen source.

### 5. Adaptive auto-pulse:

h. To ensure oxygen delivery to the pilot and passengers at all times, the oxygen ports could be equipped with adaptive auto-pulse (see references) to deliver the correct minute volume of oxygen in the absence of breath detection.
   6. Pilot selective delivery:

### The oxygen conserver could alter the delivery of oxygen to maintain delivery to the pilot in preference over the passengers if the conserver's source pressure sensor detected a drop in the source pressure

Other modes of operation may suggest themselves to one skilled in the art given the flexibility of the novel conserver.

A visual confirmation that oxygen is being delivered such as an LED indicator is advantageous as well.

Another embodiment of the distributed conserver design could include a number of satellite conservers in communication with a main control unit at the oxygen source. This concept is similar in principle to the communication concepts identified in referenced patent application Ser. No. 11/274,755 However, in an aircraft environment, each seat could have an integrated conserving device with a common supply. With a rate limited supply, each seat conserver would communicate via hardwire or RF communication to the source controller to balance the oxygen demand to the oxygen supply, in order to achieve modes of operation such as described above. In this embodiment, the source unit would provide the CPU functions described above.

We claim:

1. A multi-port oxygen conserver system for general aviation, comprising:
at least one oxygen source input,
at least pilot oxygen output port and at least one passenger output port, wherein each port comprises a breath pressure sensor and a gas control valve, and each conserver includes
an ambient pressure input; and a CPU, adapted to acquire the breath pressure sensors' data and the ambient pressure input data and to independently control the valves' timing.

2. The conserver system of claim 1 where the ambient pressure input is connected to least one of an ambient pressure sensor integrated into the conserver or a pressure measuring system from the aircraft instrumentation.

3. The conserver system of claim 1 further comprising,
at least one back-up oxygen source port,
a pressure sensor adapted to read the source pressure and be read by the CPU; and,
a source control valve, controlled by the CPU adapted to select either the primary source or the back-up source or both.

4. The conserver system of claim 1 wherein the CPU is adapted to switch in the back-up source in addition to the primary source when the primary source does not have adequate capacity.

5. The conserver system of claim 1 further comprising a user input panel adapted to communicate with the CPU.

6. The conserver system of claim 5 wherein the valves' timing is determined in part by individual pilot and passenger flow settings input from the user interface panel.

7. The conserver system of claim 5 wherein the valves' timing is determined in part by a pilot only flow settings input from the user interface panel.

8. The conserver system of claim 5 wherein the valves' timing is determined in part by pilot selected flow settings for all ports input from the user interface panel.

9. The conserver system of claim 1 wherein the valves' timing is determined in part by the oxygen production capacity of the primary oxygen source.

10. The conserver system of claim 1 wherein the valves' timing is determined in part by at least one of;
production capacity distribution,
altitude adjusting flow setting, or;
adaptive auto-pulse.
